(19) United States
(12) Patent Application Publication
(10) Pub. No.: US 2024/0157517 A1
(43) Pub. Date: May 16, 2024

(54) TWEEZER DEVICE

(71) Applicant: HAKKO CORPORATION, Osaka (JP)

(72) Inventors: Takanori NAITO, Osaka City (JP); Mitsuhiko MIYAZAKI, Osaka City (JP); Kensuke HAMADA, Osaka City (JP)

(21) Appl. No.: 18/219,071

(22) Filed: Jul. 6, 2023

(30) Foreign Application Priority Data
Nov. 15, 2022 (JP) 2022-182644

(51) Int. Cl. B25B 9/02

(52) U.S. Cl. CPC B25B 9/02

(57) ABSTRACT

To provide a tweezer device in which the feel of gripping a housing does not change even when the tips are adjusted in the vertical direction.

A tweezer device 10 includes a housing 12 configured to change the distance between the distal end of a first housing 13 and the distal end of a second housing 12; a first socket 27 which is arranged in the first housing 13 and into which the proximal end of the first tip 1 can be inserted; a displace mechanism 34 for vertically displacing the first socket 27; and a support member 44 functioning as a rotating fulcrum of the first tip 1 so as to be displaced in the vertical direction by the displacement of the distal end of the first tip 1 whose proximal end is inserted in the first socket 27 in the vertical direction. The first housing 13 has an internal space S1 that allows displacement of the first socket 27 in the vertical direction.

### FIELD OF ART

This disclosure relates to tweezer devices.

### BACKGROUND ART

A tweezer device used for soldering and removing electronic parts is known. A tweezer device of this type is disclosed, for example, in Patent Document 1 below, and the tweezer device disclosed in this document is coupled to each other so as to be rotatable about a rotation shaft 81 as shown in FIGS. 11 and 12. The pair of leg members 82 and 83 are provided with mounting portions 85 and 86 for mounting the tips 101 and 102, respectively. In this tweezer device, not only the pair of leg members 82 and 83 are opened and closed so that the width between the distal ends of the tips 101 and 102 can be changed, but also the tips 101 and 102 can be adjusted (that is, adjustment in the back and forth direction) by moved along the length direction of the tips 101 and 102. That is, by rotating a knob 87 provided on the mounting portions 85 and 86, the mounting portions 85 and 86 can be moved in the back and forth direction, thereby adjusting the tips 101 and 102 in the back and forth direction.

In this tweezer device, the positional relationship of the distal ends of both tips 101 and 102 can be adjusted in the longitudinal direction of the rotation shaft 81 (the direction perpendicular to the plane along the opening/closing trajectory of the tips 101 and 102). That is, one leg member 82 is provided with a position adjusting wheel 89, and by rotating this wheel 89, the distal end of one leg member 83 can be moved in the vertical direction of the rotation shaft 81. As a result, the positional relationship between the distal ends of the leg members 82 and 83 is changed, thereby adjusting the positional relationship between the tips 101 and 102 in the vertical direction.

Since the housings 91, 92 are fixed to the pair of leg members 82, 83, respectively, when the pair of leg members 82, 83 are opened and closed, the pair of housings 91, 92 are also move in unison with the pair of leg members 82, 83. Further, when vertical adjustment is made by the position adjusting wheel 89, one housing 92 is moved integrally with one leg member 83 to which the housing 92 is attached.

### PRIOR ART

### Patent Document

[Patent Document 1] JP-A-2022-111429

### SUMMARY OF INVENTION

### Problems to be Solved

In the tweezer device disclosed in Patent Document 1, the ends of the iron tips 101 and 102 can be adjusted not only in the back and forth direction but also in the vertical direction, which makes it possible to mount and remove very fine electronic components. However, when adjusting the tips 101 and 102 in the vertical direction, one housing 92 moves integrally with the movement of one leg member 83, so the positional relationship between both housings 91 and 92 changes. That is, the distal end of one housing 92 is displaced relative to the distal end of the other housing 91 in the longitudinal direction of the rotation shaft 81. For this reason, the feeling when gripping both housings 91 and 92 changes, and the feeling of use of the tweezer device may change when very delicate work is performed.

The present invention has been made in view of the above-mentioned prior art, and an object of the present invention is to maintain a feeling when gripping the housing even when adjusting the tips of the iron in the vertical direction.

### Problem to be Addressed

To achieve the above object, a tweezer device comprising a first housing and a second housing, wherein said first housing and said second housing rotate about a rotation shaft so that the distance between the distal end of the first housing and the distal end of the second housing can be changed; a first socket arranged in said first housing into which the proximal end of the first tip can be inserted; a second socket arranged in the second housing into which the proximal end of the second tip can be inserted; a displace mechanism for displacing said first socket in the longitudinal direction of the rotation shaft; a support member that functions as a rotating fulcrum for said first tip so that said distal end of the first tip, the proximal end of which is inserted into said first socket, is displaced in the longitudinal direction of the rotation shaft by the displacement of said first socket in the longitudinal direction of the rotation shaft; and said first housing having an internal space that allows displacement of said first socket in the longitudinal direction of the rotation shaft.

The tweezer device according to the present invention can be used with the first and second tips inserted into the first and second sockets. In this tweezer device, the first housing and the second housing can be opened and closed so that the distance between the distal end of the first housing and the distal end of the second housing is changed. By this opening and closing operation, the electronic component can be hold between the distal end of the first tip and the distal end of the second tip. Further, the displace mechanism can displace the first socket in the longitudinal direction of the rotation shaft. At this time, the support member functions as a rotating fulcrum of the first tip, and the first tip can be moved. As a result, since the end of the first tip can be displaced in the longitudinal direction of the rotation shaft, the relative positional relationship between the end of the first tip and the end of the second tip in the longitudinal direction of the rotation shaft can be changed. At this time, the relative positional relationship between the first housing and the second housing remains unchanged. That is, although the first socket is arranged in the internal space of the first housing, the first socket is displaced independently of the first housing, so that the first housing is not affected by it, and the first housing itself does not displace (or do not change its orientation in the vertical direction) even if the first socket is displaced in the longitudinal direction of the rotation shaft. Therefore, even if the first socket is displaced by the displace mechanism, the feeling of gripping the housing does not change, and thus it is possible to prevent the feeling of use from changing when extremely delicate work is performed.

The support member is configured to hold the first tip having proximal end is inserted into the first socket, and the point of the first tip held by the support member serves as the rotating center of the first tip. In this aspect, when the first socket is displaced in the longitudinal direction of the rotation shaft by the displace mechanism, the first tip moves around the point held by the support member.

The displace mechanism includes a rotatable operating member, a shaft that rotates when the operating member rotates, and a socket receiving member into which the first socket is inserted is displaced in the longitudinal direction of said rotation shaft by orbital rotation of said shaft.

In this aspect, when the user rotates the operating member, the shaft revolves, thereby displacing the socket receiving member in the longitudinal direction of the rotation shaft. Since the socket receiving member is configured to receive the first socket, when the socket receiving member is displaced in the longitudinal direction of the rotation shaft, the first socket is also displaced in the same direction.

The first housing has a stopper member for restricting displacement of the socket receiving member to prevent displacement in the direction of insertion of the first tip into the first socket, the socket receiving member receives the first socket such that the first socket is displaceable relative to the socket receiving member in the insertion direction of the first tip.

In this aspect, the stopper member restricts displacement of the socket receiving member in the direction in which the first tip is inserted into the first socket. This eliminates the need for a space for allowing the displacement of the socket receiving member in the insertion direction, and the first housing can be made smaller accordingly. On the other hand, the first socket is displaceable with respect to the socket receiving member in the insertion direction of the first tip.

The tweezer device may include an adjusting member held by the first housing for displacing the first socket in the insertion direction of the first tip. The first housing may have a restricting member that restricts displacement of the adjusting member in the insertion direction of the first tip while allowing displacement of the first socket and the adjusting member in the longitudinal direction of the rotation shaft.

In this aspect, the adjusting member can displace the first socket in the insertion direction of the first tip. Thereby, the length of the first tip can be adjusted. At this time, since the adjusting member itself is not displaced in the insertion direction of the first tip, only the first socket is displaced. On the other hand, the adjusting member is displaced in the longitudinal direction of the rotation shaft. Therefore, the restricting member of the first housing restricts displacement of the adjusting member in the insertion direction of the first tip, but does not restrict displacement of the first socket in the longitudinal direction of the rotation shaft.

The support member comprising an O-ring made of a heat-resistant material and arranged to hold the first tip. In this aspect, the first housing is not damaged by the heat of the first tip.

The support member may be provided on the first housing, the first socket, or the socket receiving member.

### Effect of the Invention

In this invention, even when adjusting the tip in the vertical direction, the feeling of gripping the housing does not change, and thus it is possible to prevent the feeling of use from changing when extremely delicate work is performed.

### BRIEF DESCRIPTION OF THE DRAWING

FIG. 1 is a perspective view of a tweezer device.

FIG. 2 is a bottom view of the tweezer device.

FIG. 3 is a perspective view of a first inner member of a first housing provided on the tweezer device.

FIG. 4 is a perspective view of a second inner member of a second housing provided on the tweezer device.

FIG. 5 is a view for explaining the internal structure of the first housing.

FIG. 6 is a view for explaining the internal structure of the second housing.

FIG. 7 is a view for explaining a displace mechanism for vertically displacing a first socket arranged in the first housing.

FIG. 8 is a views for explaining projections for restricting displacement of the socket receiving member in the back and forth direction.

FIG. 9 is a view for explaining a modification of the support member.

FIG. 10 is a view for explaining a modification of the support member.

FIG. 11 is a perspective view of a conventional tweezer device.

FIG. 12 is a view for explaining the internal structure of the conventional tweezer device;

### EMBODIMENT OF THE INVENTION

Hereinafter, embodiments for carrying out the present invention will be described in detail with reference to the drawings.

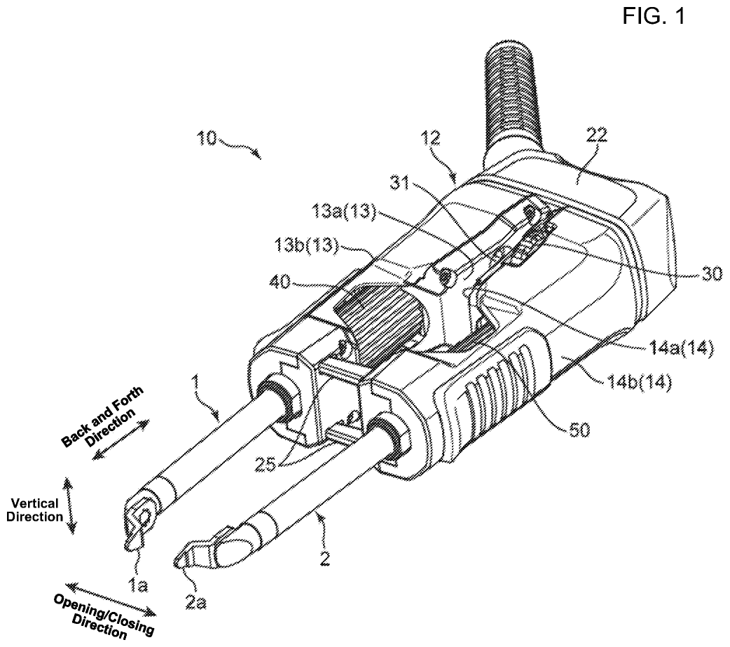

As described in FIG. 1, a tweezer device 10 according to the present embodiment is used with a first tip 1 and a second tip 2 inserted into a housing 12 which will be described later. The heated first and second tips 1 and 2 are used for the operation of removing fine electronic parts from a circuit board or mounting them on a circuit board while pinching the electronic parts.

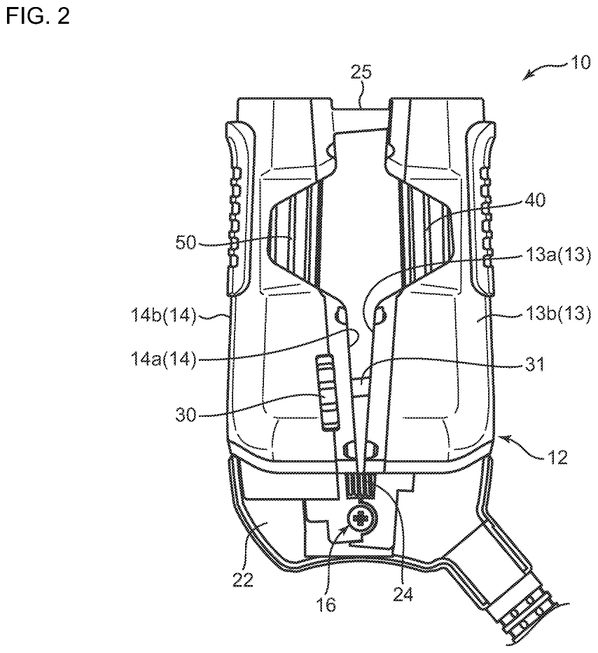

As described in FIGS. 1 and 2, the tweezer device 10 has a housing 12 including a first housing 13 into which the first tip 1 can be inserted, and a second housing 14 into which the second tip 2 can be inserted. The first housing 13 and the second housing 14 are configured to be rotatable about a rotation shaft 16. By rotating the first housing 13 and the second housing 14 about the rotation shaft 16, the distance between the distal end 1a of the first tip 1 and the distal end 2a of the second tip 2 can be changed in the opening and closing direction. As a result, a fine electronic component can be held between the distal end 1a of the first tip 1 and the distal end 2a of the second tip 2. As. In other words, the opening and closing direction is a direction perpendicular to the rotation shaft 16 and parallel to the plane defined by the trajectories of the first tip 1 and the second tip 2 moving around the rotation shaft 16.

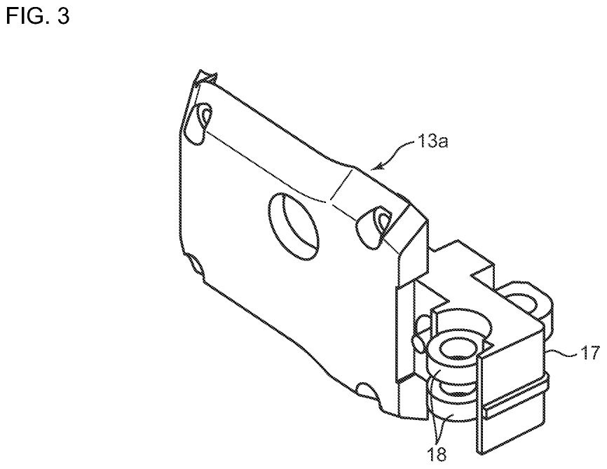

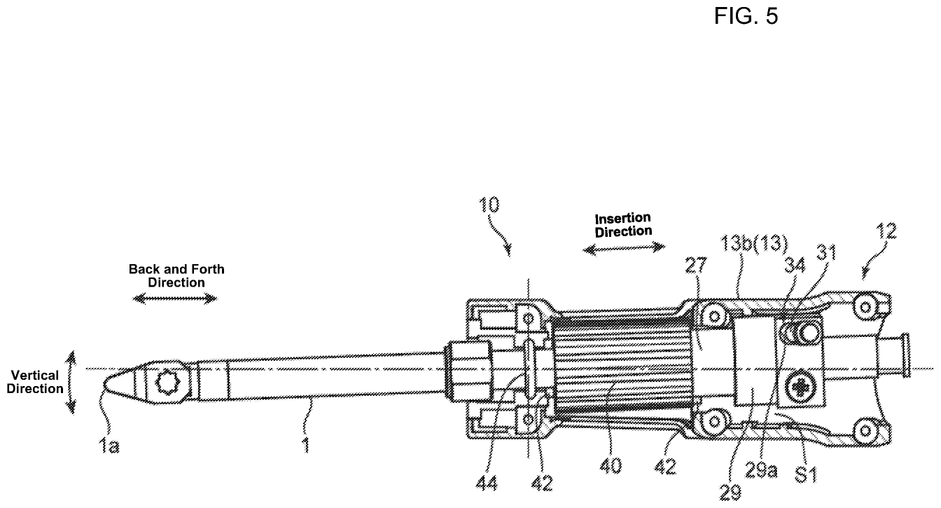

The first housing 13 has a first inner member 13a (FIG. 3) and a first outer member 13b. By combining the first inner member 13a and the first outer member 13b, it is formed in a hollow shape having an internal space S1 (FIG. 5). A first socket 27, a socket receiving member 29, which will be described later, are arranged in the internal space S1.

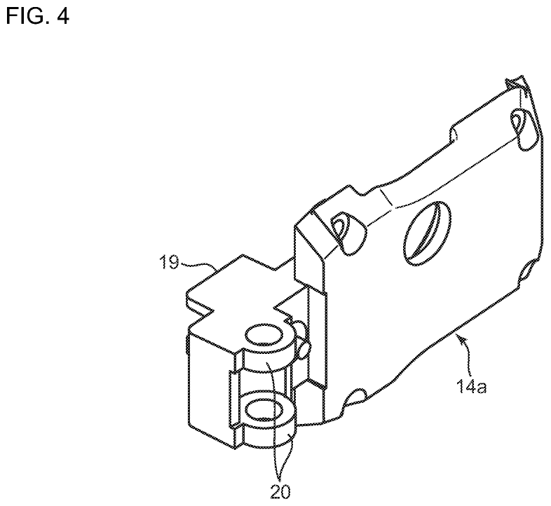

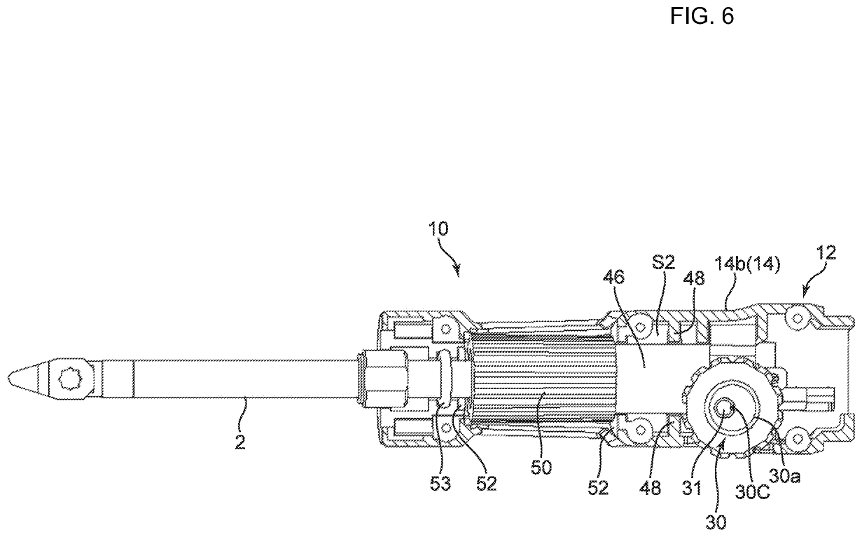

The second housing 14 has a second inner member 14a (FIG. 4) and a second outer member 14b. By combining the second inner member 14a and the second outer member 14b, it is formed in a hollow shape having an internal space S2 (FIG. 6). A second socket 46, which will be described later, are arranged in the internal space S1.

As shown in FIG. 2, the first housing 13 and the second housing 14 are arranged such that the outer surface of the first inner member 13a and the outer surface of the second inner member 14a face each other. As shown in FIG. 3, the first inner member 13a is provided with an extending portion 17, and the extending portion 17 is formed with a first insertion portion 18 through which the rotation shaft 16 is inserted. As shown in FIG. 4, the second inner member 14a is provided with an extending portion 19, and the extending portion 19 is provided with a second insertion portion 20 through which the rotation shaft 16 is inserted. Each of the first insertion portion 18 and the second insertion portion 20 is formed by a pair of cylindrical portions parallel to each other at the longitudinal end surfaces of the rotation shaft 16. Therefore, one cylindrical portion is formed by overlapping the first insertion portion 18 and the second insertion portion 20. By inserting the rotation shaft 16 into this cylindrical portion, the first inner member 13a and the second inner member 14a are brought into a state of being rotatable around the rotation shaft 16. At this time, the longitudinal end face of the rotary shaft 16 in the first insertion 18 and the longitudinal end face of the rotary shaft 16 in the second insertion 20 are in surface contact. Therefore, there is little allowance between the first insertion portion 18 and the second insertion portion 20. Therefore, the first inner member 13a (first housing 13) and the second inner member 14a (second housing 14) can rotate around the rotation shaft 16 without being twisted. Note that the longitudinal direction of the rotation shaft 16 is also referred to as the vertical direction.

The extending portion 17 having the first insertion portion 18 and the extending portion 19 having the second insertion portion 20 are covered with a proximal end housing 22. In the proximal housing 22, a biasing member 24 (FIG. 2) are provided so that first housing 13 and second housing 14 are biased in the direction that extending the distance between distal end 1a of the first tip 13 and distal end 2a of the second tip 2. However, a guide member is provided between the distal end of the first housing 13 and the distal end of the second housing 14 so that the distance between the distal end 1a of the first tip 1 and the distal end 2a of the second tip 2 does not extend beyond a predetermined width. The guide member 25 prevent the first housing 13 and the second housing 14 from twisting such that the distal end of the first housing 13 and the distal end of the second housing 14 are displaced in the longitudinal direction of the rotation shaft 16.

The first socket 27 arranged in the internal space S1 of the first housing 13 is configured so that the proximal end of the first tip 1 can be inserted therein. Conductive terminals (not shown) are provided to the first socket 27 so as to be electrically conductive to terminals (not shown) provided at the proximal end of the first tip 1. An electric wire including a power line and a signal line is connected to the first socket 27. With the first tip 1 inserted into the first socket 27, electric power and signals from the wire are supplied to the first tip 1 through the conductive terminals and terminals. That is, the first tip 1 can be attached to the first socket 27, and electric power can be supplied to the first tip 1 in a state in which the first tip 1 is attached to the first socket 27.

The first socket 27 passes through a socket receiving member 29 formed in a cylindrical shape. That is, the socket receiving member 29 is configured to receive the first socket 27. The through hole through which the first socket 27 penetrates in the socket receiving member 29 extends in the longitudinal direction of the first socket 27 (or the insertion direction in which the first tip 1 is inserted into the first socket 27), the first socket 27 passes through the socket receiving member 29 in this direction. In this state, the first socket 27 is relatively movable with respect to the socket receiving member 29 in the insertion direction.

The socket receiving member 29, the operating member 30 and the shaft 31 constitute the displace mechanism 34 for displacing the first socket 27 in the longitudinal direction of the rotation shaft 16 (also referred to as the vertical direction). As the socket receiving member 29 and the first socket 27 are displaced in the vertical direction, the first tip 1 inserted into the first socket 27 moves, whereby the distal end 1a of the first tip 1 moves vertically.

That is, as will be described later, since the first tip 1 is moveably held by the support member 44, the displacement of the socket receiving member 29 and the first socket 27 in the vertical direction causes the first tip 1 to move. Specifically, as the socket receiving member 29 and the first socket 27 are displaced in the vertical direction, the first tip 1 moves together with the first socket 27. At this time, the first socket 27 and the socket receiving member 29 slightly change their directions as the first soldering tip 1 moves about the portion supported by the support member 44. That is, the first socket 27 and the socket receiving member 29 are housed in the first housing 13 in a moveable state. The moving direction at this time is a direction perpendicular to the plane along the trajectory of the housings 13 and 14 when the first housing 13 and the second housing 14 rotate about the rotation shaft 16.

The operating member 30 is a wheel-shaped member that is rotatably held in the second housing 14 and is exposed from the second housing 14 through a notch formed in the second housing 14. Therefore, the operating member 30 can be operated from outside the second housing 14.

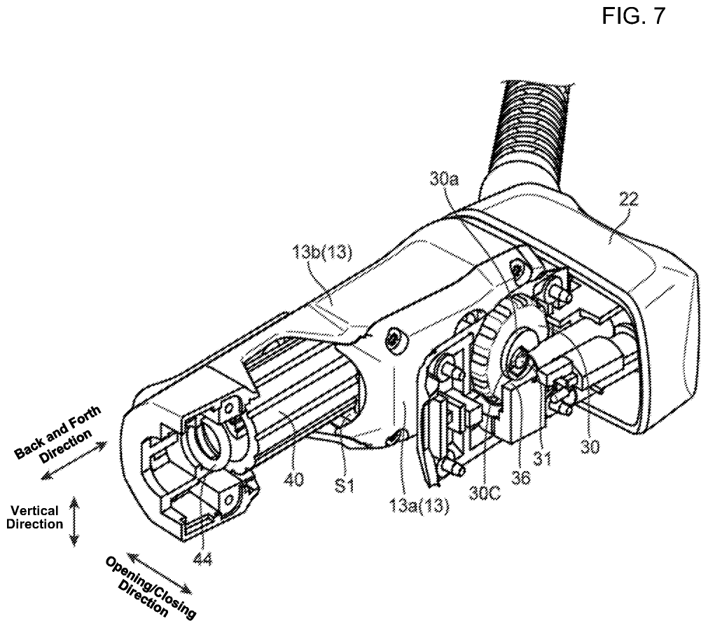

A disc portion 30a is formed integrally with the operating member 30. By holding the disc portion 30a in a guide member 36 (FIG. 7) provided in the second housing 14, the operating member 30 is rotatable about the center 30C of the operating member 30 as an axis.

As shown in FIG. 7, the shaft 31 is provided parallel to the opening/closing direction at a position eccentric from the center 30C of the operating member 30, and the operating member 30 is operated, shaft 31 revolves around center 30C of operating member 30. The shaft 31 passes through a hole formed in the second inner member 14a and a hole formed in the first inner member 13a and is inserted into the internal space S1 of the first housing 13.

As shown in FIG. 5, the distal end of the shaft 31 is inserted into a long hole 29a formed in the socket receiving member 29. The long hole 29a is long shape in the direction in which the first socket 27 penetrates in the socket receiving member 29 or in the insertion direction (or the back and forth direction) in which the first tip 1 is inserted into the first socket 27. In this insertion direction, the dimension of the long hole 29a is longer than the passage range of the shaft 31 when the shaft 31 revolves. On the other hand, in the direction orthogonal to the insertion direction and parallel to the vertical direction (longitudinal direction of the rotation shaft 16), the dimension of the long hole 29a is shorter than the passage range of the shaft 31 when the shaft 31 revolves. The socket receiving member 29 includes a cylindrical portion that receives the first socket 27 and a plate-like portion that has a long hole 29a. These cylindrical portion and plate-like portion may be configured by separate members.

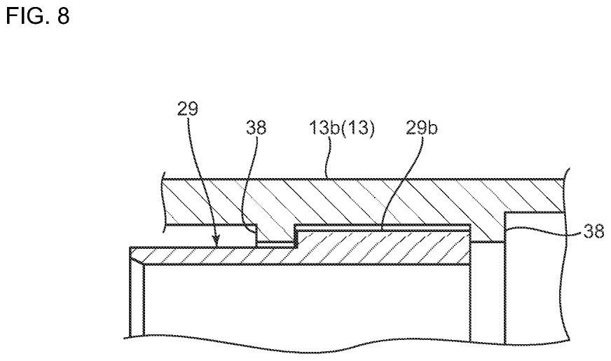

The first housing 13 is provided with a stopper member 38 for restricting displacement of the socket receiving member 29 in the insertion direction of the first tip 1 into the first socket 27 (back and forth direction). That is, as shown in FIG. 8, the outer peripheral surface of the socket receiving member 29 is provided with a projection 29b having a predetermined length in its axial direction. Stopper member 38 is provided on the inner peripheral surface of the first housing 13 so that the projection 29b is sandwiched in the insertion direction. Therefore, the socket receiving member 29 is not displaced in the insertion direction of the first tip 1. When the shaft 31 revolves, the socket receiving member 29 is not displaced in the insertion direction (or the back and forth direction) of the first tip 1, but is displaced in the vertical direction (longitudinal direction of the rotation shaft 16). At this time, the first socket 27 is also vertically displaced together with the socket receiving member 29. Note that the projection 29b is not shown in FIG. 5 because it is positioned at the back of the socket receiving member 29.

The socket receiving member 29 and the first socket 27 are arranged in the internal space S1 of the first housing 13. The internal space S1 is sized to allow vertical displacement of the socket receiving member 29 and the first socket 27. Therefore, even if the socket receiving member 29 and the first socket 27 are displaced in the vertical direction, the first housing 13 is not affected and the first housing 13 is not displaced.

An adjusting member 40 for displacing the first socket 27 in the insertion direction of the first tip 1 is held in the first housing 13. The adjusting member 40 is exposed to the outside of the first housing 13 through a notch formed in the first housing 13. Therefore, the adjusting member 40 can be operated from the outside. The adjusting member 40 is formed in a cylindrical shape that can rotate about an axis, and the first tip 1 inserted into the first socket 27 is inserted through the adjusting member 40.

An internal thread (not shown) is formed on the inner surface of the adjusting member 40, and an external thread (not shown) is formed on the outer surface of the first socket 27 to engage with the internal thread. Therefore, when the adjusting member 40 rotates around the axis, the first socket 27 moves in the axial direction (the insertion direction of the first tip 1 into the first socket 27 or longitudinal direction of the first tip 1) relative to the adjusting member 40. When the first socket 27 is displaced in the insertion direction of the first tip 1, the first tip 1 inserted into the first socket 27 is displaced in its longitudinal direction. Therefore, the distal end 1a of the first tip 1 can be moved in the back and forth direction (the direction in which the first tip 1 protrudes from the first housing 13). That is, the socket receiving member 29 receives the first socket 27 so that the first socket 27 can be displaced relative to the socket receiving member 29 in the insertion direction of the first tip 1. Since the first housing 13 is provided with the stopper member 38, even when the first socket 27 is displaced in the insertion direction of the first tip 1, the socket receiving member 29 does not move in the insertion direction of the first tip 1.

The first housing 13 has a restricting member 42 that restricts displacement of the adjusting member 40 in the insertion direction of the first tip 1. The restricting member 42 on the proximal end side has a shape extending in a direction orthogonal to the insertion direction on the inner surface of the first outer member 13b of the first housing 13 and abuts on the proximal side end face of the adjusting member 40. On the other hand, the restricting member 42 on the distal end side extends along the inner surface of the first outer member 13b in a direction orthogonal to the insertion direction, and abuts on the distal side end face of the adjusting member 40. Therefore, even when the adjusting member 40 is rotated about its axis, it is possible to prevent the adjusting member 40 from being displaced in the insertion direction of the first tip 1.

The first housing 13 is provided with a support member 44 which functions as a rotating fulcrum of the first tip 1 inserted into the first socket 27 when the first socket 27 is displaced in the vertical direction. The support member 44 holds the first tip 1 so that the portion of the first tip 1 supported by the support member 44 become the rotating center of the first tip 1 when the first tip 1 moves as the first socket 27 is displaced in the vertical direction. The support member 44 is arranged at the distal end of the first housing 13. That is, the support member 44 is arranged on the distal end of the first housing beyond the adjusting member 40. The support member 44 is composed of an O-ring made of a heat-resistant material.

A second socket 46 arranged in the internal space S2 of the second housing 14 is configured so that the proximal end of the second tip 2 can be inserted therein. A conductive terminals (not shown) are provided to the second socket 46 so as to be electrically connected to a terminal (not shown) provided at the proximal end of the terminal 2. An electric wire including a power line and a signal line is connected to the second socket 46. With the second tip 2 inserted into the second socket 46, electric power and signals from the wire are supplied to the second tip 2 through the conductive terminals and terminals. That is, the second tip 2 can be attached to the second socket 46, and electric power can be supplied to the second tip 2 in a state in which the second tip 2 is attached to the second socket 46.

Unlike the first socket 27, the second socket 46 is not vertically displaceable. That is, as shown in FIG. 6, a pair of fixing member 48 are provided on the inner surface of the second outer member 14b of the second housing 14 so as to protrude inward. The second socket 46 is fixed in the internal space S2 in a state of being sandwiched from both sides in the vertical direction by the fixing member 48. Therefore, since the second socket 46 is not displaced in the vertical direction, the second tip 2 inserted into the second socket 46 does not move vertically.

A second adjusting member 50 is held in the second housing 14 for displacing the second socket 46 in the insertion direction of the second tip 2. The second adjusting member 50 is exposed to the outside of the second housing 14 through a notch formed in the second housing 14. Therefore, the second adjusting member 50 can be operated from the outside. The second adjusting member 50 is formed in a cylindrical shape that can rotate about an axis, and the second tip 2 inserted into the second socket 46 is inserted through the second adjusting member 50.

An internal thread (not shown) is formed on the inner surface of the second adjusting member 50, and an external thread (not shown) is formed on the outer surface of the second socket 46 to engage with the internal thread. Therefore, when the second adjusting member 50 rotates around the axis, the second socket 46 moves in the axial direction (the direction of the second tip 2 into the second socket 46 or longitudinal direction of the second tip 2) relative to the second adjusting member 50. When the second socket 46 is displaced in the insertion direction of the second tip 2, the second tip 2 inserted into the second socket 46 is displaced in its longitudinal direction. Therefore, the distal end 2a of the second tip 2 can be moved in the back and forth direction (the direction in which the second tip 2 protrudes from the second housing 14). The displacement of the second adjusting member 50 in the insertion direction of the second tip 2 is restricted by a second restricting member 52 provided in the second housing 14.

A holding member 53 for holding the second tip 2 inserted into the second socket 46 is fixed to the second housing 14. The holding member 53 is arranged at the distal end of the second housing 14. That is, the holding member 53 is arranged on the distal end of the second housing 14 beyond the second adjusting member 50. The holding member 53 is composed of an O-ring made of a heat-resistant material.

When using the tweezer device 10 according to this embodiment, the first tip 1 is attached to the first housing 13 and the second tip 2 is attached to the second housing 14. At this time, the first tip 1 is inserted into the first housing 13 from the distal end of the first housing 13, passes through the support member 44 and the adjusting member 40, and is inserted into the first socket 27. Also, the second tip 2 is inserted into the second housing 14 from the distal end of the second housing 14, passes through the holding member 53 and the second adjusting member 50, and is inserted into the second socket 46.

In this state, the first housing 13 and the second housing 14 are gripped, and the housings 13 and 14 are moved so that the distance between the distal end 1a of the first tip 1 and the distal end 2a of the second tip 2 is narrowed. By closing, the electronic component can be sandwiched between both the tips 1 and 2. At this time, by operating at least one of the adjusting member 40 and the second adjusting member 50, the relative positional relationship between the distal end 1a of the first tip 1 and the distal end 2a of the second tip 2 in the back and forth direction can be adjusted. By operating the operating member 30, the position of the first socket 27 can be adjusted in the vertical direction, thereby adjusting the position of the distal end 1a of the first tip 1 in the vertical direction. Thereby, the relative positional relationship between the distal end 1a of the first tip 1 and the distal end 2a of the second tip 2 in the vertical direction can be adjusted. An operation of pinching the fine electronic parts may be performed while making above adjustments appropriately.

In the tweezer device 10 in this embodiment, the first housing 13 and the second housing 14 can be opened and closed so that the distance between the distal end of the first housing 13 and the distal end of the second housing 14 is changed. By this opening and closing operation, the electronic component can be sandwiched between the distal end 1a of the first tip 1 and the distal end 2a of the second tip 2. Further, the displace mechanism 34 can displace the first socket 27 in the longitudinal direction (vertical direction) of the rotation shaft 16. At this time, the support member 44 functions as a rotating fulcrum of the first tip 1, and the first tip 1 can be moved. As a result, the distal end 1a of the first tip 1 can be displaced in the longitudinal direction (vertical direction) of the rotation shaft 16, so that the relative positional relationship between the distal end 1a of the tip 1 and the distal end 2a of the tip 2 can be changed. At this time, the relative positional relationship between the first housing 13 and the second housing 14 remains unchanged. That is, although the first socket 27 is arranged in the internal space S1 of the first housing 13, the first socket 27 is independently displaced with respect to the first housing 13, so that even when the first socket 27 is displaced in the longitudinal direction of the rotation shaft 16, the first housing 13 is not affected by the displacement, and the first housing 13 itself is not displaced (or does not change its orientation in the vertical direction). Therefore, even if the first socket 27 is displaced by the displace mechanism 34, the feeling of gripping the housing 12 does not change, and thus it is possible to prevent the feeling of use from changing when extremely delicate work is performed.

The user rotates the operating member 30, the shaft 31 revolves, thereby displacing the socket receiving member 29 in the longitudinal direction (vertical direction) of the rotation shaft 16. Since the socket receiving member 29 is configured to receive the first socket 27, when the socket receiving member 29 is displaced in the longitudinal direction of the rotation shaft 16, the first socket 27 is also displaced in the same direction. Thereby, the relative positional relationship between the distal end 1a of the first tip 1 and the distal end 2a of the second tip 2 can be changed.

A stopper member 38 restricts the displacement of the socket receiving member 29 in the direction in which the first tip 1 is inserted into the first socket 27. On the other hand, the first socket 27 is displaceable with respect to the socket receiving member 29 in the insertion direction of the first tip 1.

The adjusting member 40 allows the first socket 27 to be displaced in the insertion direction of the first tip 1. Thereby, the length of the first tip 1 can be adjusted. At this time, since the adjusting member 40 itself is not displaced in the insertion direction of the first tip 1, only the first socket 27 is displaced. On the other hand, the adjusting member 40 is displaced in the vertical direction (longitudinal direction of the rotation shaft 16). Therefore, the restricting member 42 of the first housing 13 restricts the displacement of the adjusting member 40 in the insertion direction of the first tip 1, but does not restrict the displacement of the first socket 27 in the vertical direction.

Further, since the support member 44 is formed of an O-ring made of a heat-resistant material, the first housing 13 is not damaged by the heat of the first tip 1.

### OTHER EMBODIMENTS

It should be noted that the embodiments disclosed here should be considered as examples and not restrictive in all respects. The present invention is not limited to the embodiments described above, and various modifications and improvements are possible without departing from the scope of the invention. For example, although the second socket 46 is provided inside the second housing 14 so as not to be displaced in the vertical direction, it is not limited to this. Similarly to the first socket 27, the second socket 46 may be configured to be vertically displaceable. That is, a second displace mechanism (a mechanism similar to the displace mechanism 34) for displacing the second socket 46 in the longitudinal direction of the rotation shaft 16 may be provided. In this case, the second displace mechanism may comprise a rotatable second operating member, a second shaft that revolves when the second operating member rotates, a second socket receiving member that a second socket 46 is inserted into and displace in the longitudinal direction of the rotation shaft 16 by revolving the second shaft.

The tweezer device 10 includes an adjusting member 40 for displacing the first socket 27 in the insertion direction (back and forth), but the adjusting member 40 may be omitted. Similarly, the second adjusting member 50 can also be omitted.

In the above-described embodiment, the support member 44 is composed of an O-ring. However it is not limited to O-ring as long as it is heat resistant and does not transfer heat from the first tip 1 to the first housing 13. Note that support member 44 should have a configuration that does not hinder the moving of the first tip 1 as the first socket 27 is displaced in the vertical direction. For example, the support member 44 may be formed in the shape of a thin plate so that the portion of the first tip 1 held by the support member 44 serves as the rotating center.

The holding member 53 is also not limited to the O-ring. Since the second tip 2 does not move, the holding member 53 does not have to be made of a material that does not impede the movement of the second tip 2 as long as the material is made of a material that is heat-resistant and does not transfer the heat of the second tip 2 to the second housing 14.

In the above embodiment, the support member 44 is configured as an O-ring held by the first housing 13, but is not limited to this. For example, the support member 44 may be configured by a plate-like member that supports the first tip 1 so as to function as a rotating fulcrum of the first tip 1. This plate-shaped member is fixed to the first housing 13 and holds the first tip 1 moveably.

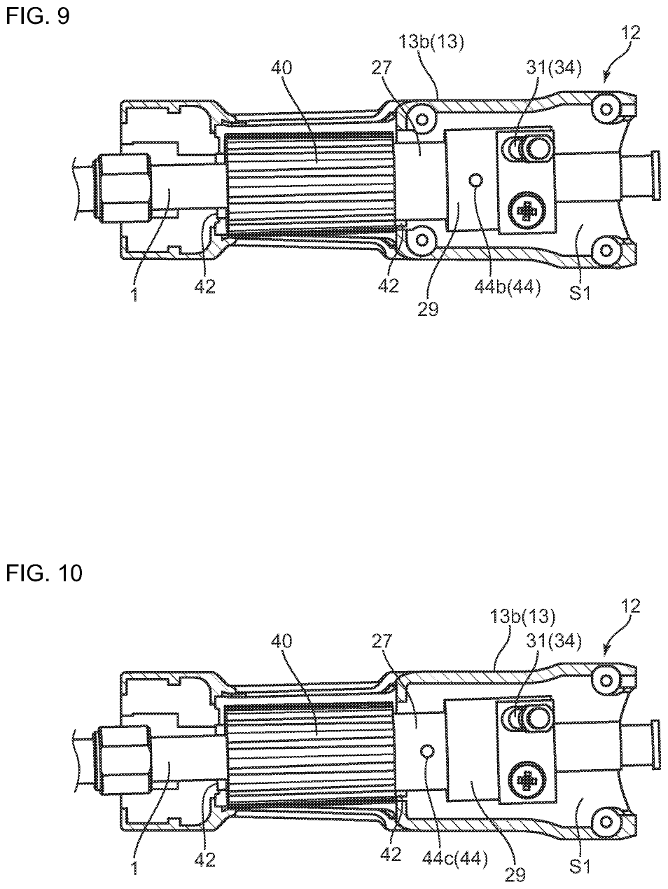

The configuration of the support member 44 is not limited to directly supporting the first tip 1. For example, the support member 44 may be configured by a cylindrical projection 44b provided on the socket receiving member 29, as shown in FIG. 9. The projections 44b protrude from both outer surfaces of the socket receiving member 29 in the left-right direction (front direction and back direction in FIG. 9) at positions on more the distal end side than the shaft 31 of the displace mechanism 34. In FIG. 9, the projection 44b on the front side is shown, but the projection positioned on the back side of the socket receiving member 29 is not visible. The projection 44b located inside in the opening/closing direction is received by a recess provided in the first inner member 13a of the first housing 13 so as to be rotatable about the axis of the projection 44b. The projection located outside in the opening/closing direction is received by a recess provided in the first outer member 13b of the first housing 13, so as to be rotatable about the axis of the projection. In this case, the O-ring for holding the first tip 1 is omitted, and the projection 44b of the socket receiving member 29 becomes the rotating center of the first tip 1. The projection 44b may be provided not on the socket receiving member 29 but on the first housing 13 and received by a recess provided in the socket receiving member 29.

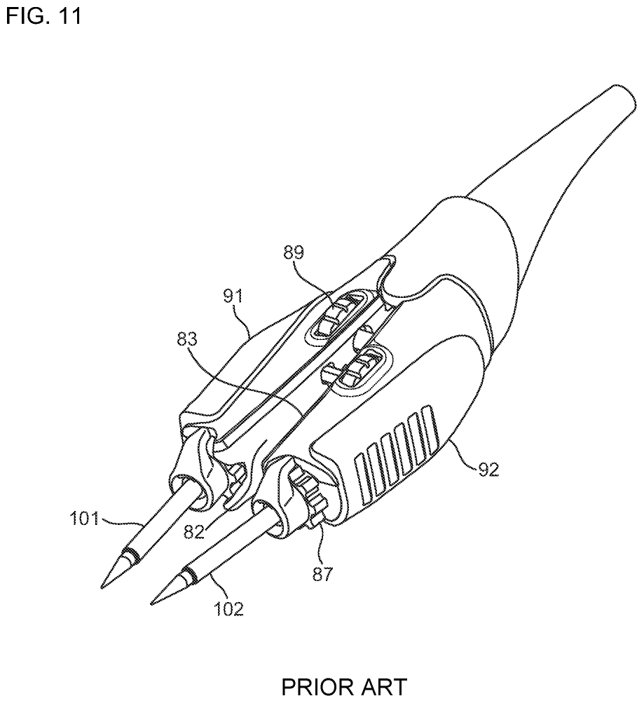

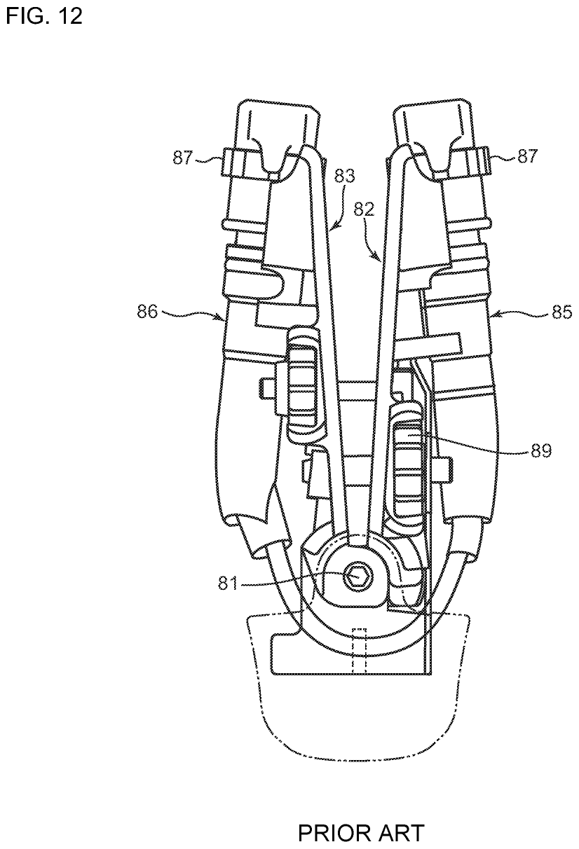

Further, the support member 44 may be configured by a cylindrical projection 44c provided on the first socket 27, as shown in FIG. 10. The projections 44c protrude from both outer surfaces of the first socket 27 in the left-right direction (front direction and back direction in FIG. 10) at positions on more the distal end side than the shaft 31. Note that FIG. 10 shows the projection 44c on the front side, but the projection located on the back side of the first socket 27 is not visible. The projection 44c located inside in the opening/closing direction is received by a recess provided in the first inner member 13a of the first housing 13 so as to be rotatable about the axis of the projection 44c. The projection located outside in the opening/closing direction is received by a recess provided in the first outer member 13b of the first housing 13 so as to be rotatable about the axis of the projection. In this case, the projection 44c of the first socket 27 becomes the rotating center. This configuration can be adopted when the first socket 27 is configured not to be displaced in the insertion direction. The projection 44c may be provided not on the first socket 27 but on the first housing 13 and received by a recess formed on the first socket 27.

### INDICATION DESCRIPTION

1: First tip
1a: Distal end
2: Second tip
2a: Distal end
10: Tweezer device
12: Housing
13: First housing
14: Second housing
16: Rotation shaft
27: First socket
29: Socket receiving member
30: Operating member
31: Shaft
34: Displace mechanism
38: Stopper member
40: Adjusting member
42: Restricting member
44: Support member
S1: Internal space

1. A tweezer device comprising:
a first housing and a second housing, wherein said first housing and said second housing rotate about a rotation shaft so that a distance between a distal end of said first housing and a distal end of said second housing can be changed;
a first socket arranged in said first housing into which a proximal end of a first tip can be inserted;
a second socket arranged in said second housing into which a proximal end of a second tip can be inserted;
a displace mechanism for displacing said first socket in a longitudinal direction of said rotation shaft;
a support member that functions as a rotating fulcrum for said first tip so that said a distal end of said first tip, said proximal end of which is inserted into said first socket, is displaced in said longitudinal direction of said rotation shaft by the displacement of said first socket in said longitudinal direction of said rotation shaft; and
said first housing having an internal space that allows displacement of said first socket in said longitudinal direction of said rotation shaft.

2. The tweezer device according to claim 1, wherein
said support member is configured to hold said first tip having said proximal end inserted into said first socket, and a point of said first tip held by said support member serves as a rotating center of the first tip.

3. The tweezer device according to claim 1, wherein
said displace mechanism includes a rotatable operating member, a shaft that rotates when said operating member rotates, and a socket receiving member into which said first socket is inserted is displaced in said longitudinal direction of said rotation shaft by orbital rotation of said shaft.

4. The tweezer device according to claim 3, wherein
said first housing has a stopper member for restricting displacement of said socket receiving member to prevent displacement in a direction of insertion of said first tip into said first socket,
said socket receiving member receives said first socket such that said first socket is displaceable relative to said socket receiving member in said insertion direction of said first tip.

5. The tweezer device according to claim 1, wherein
an adjusting member held by said first housing for displacing said first socket in an insertion direction of the first tip;
said first housing has a restricting member that restricts displacement of said adjusting member in said insertion direction of said first tip while allowing displacement of said first socket and said adjusting member in said longitudinal direction of said rotation shaft.

6. The tweezer device according to claim 2, wherein
said support member comprising an O-ring made of a heat-resistant material and arranged to hold said first tip.

7. The tweezer device according to claim 3, wherein
said support member is provided on said first housing, said first socket, or said socket receiving member.

8. The tweezer device according to claim 2, wherein
said displace mechanism includes a rotatable operating member, a shaft that rotates when said operating member rotates, and a socket receiving member into which said first socket is inserted is displaced in said longitudinal direction of said rotation shaft by orbital rotation of said shaft.

9. The tweezer device according to claim 8, wherein
said first housing has a stopper member for restricting displacement of said socket receiving member to prevent displacement in a direction of insertion of said first tip into said first socket,
said socket receiving member receives said first socket such that said first socket is displaceable relative to said socket receiving member in said insertion direction of said first tip.

10. The tweezer device according to claim 8, wherein
said support member is provided on said first housing, said first socket, or said socket receiving member.
